(19) United States
(12) Patent Application Publication
(10) Pub. No.: US 2006/0042150 A1
(43) Pub. Date: Mar. 2, 2006

(54) Two dimensional fishing lure

(75) Inventor: Warren Edward Roh, Littleton, CO (US)

Correspondence Address: LAW OFFICE OF DALE B. HALLING, LLC, 655 SOUTHPOINTE COURT, SUITE 100, COLORADO SPRINGS, CO, 80906, US

(73) Assignee: The Idea Place, LLC

(21) Appl. No.: 11/209,298

(22) Filed: Aug. 23, 2005

Related U.S. Application Data
(60) Provisional application No. 60/603,871, filed on Aug. 24, 2004.

(51) Int. Cl. A01K 85/00

(52) U.S. Cl. 43/42.37; 43/42.32; 43/42; 43/42.24

(57) ABSTRACT

A two dimensional fishing lure has a base material and is used to form two images of the lure which may be mirror images. A hook is placed between the images and the sandwich is then held together by an adhesive, stitching or mechanical means.

### RELATED APPLICATIONS

The present invention claims priority on provisional patent application Ser. No. 60/603,871, filed on Aug. 24, 2004, entitled “Two Dimensional Fishing Lure” and is hereby incorporated by reference.

### FIELD OF THE INVENTION

The present invention relates generally to the field of fishing equipment and more particularly to a two dimensional fishing lure.

### BACKGROUND OF THE INVENTION

Fishermen are constantly looking for new fishing lures. Present fishing lures are bulky and require a box to carry around. As a result, there is a need for a fishing lure that is effective and not as bulky to carry as present fishing lures.

### SUMMARY OF INVENTION

The present invention is related to a two dimensional fishing lure. A base material is used to form two images of the lure which may be mirror images. A hook is placed between the images and the sandwich is then held together by an adhesive, stitching or mechanical means. Alternatives include another punch-out that acts as a plane or fin for the lure. The base material may be a laminated paper, mylar, plastic or other material.

The two dimensional fishing lure is inexpensive, easy to use and provides an almost unlimited supply of lures. In addition, the base material may be printed on and the lure can serve as a business card, gift cards, and the like.

### BRIEF DESCRIPTION OF THE DRAWINGS

FIG. 1 is a front view of a two dimensional lure in accordance with one embodiment of the invention;

FIG. 2 is a side view of a two dimensional lure in accordance with one embodiment of the invention;

FIG. 3 is a side view of a two dimensional lure on the base material in accordance with one embodiment of the invention;

FIG. 4 is a front view of a two dimensional lure on the base material in accordance with one embodiment of the invention;

FIG. 5 is a perspective view of a two dimensional lure on the base material in accordance with one embodiment of the invention;

FIG. 6 is a perspective view of a two dimensional lure being folded over a hook in accordance with one embodiment of the invention;

FIG. 7 is a perspective view of a two dimensional lure folded over a hook in accordance with one embodiment of the invention;

FIG. 8 is a perspective view of a roll of two dimensional lures in accordance with one embodiment of the invention;

FIG. 9 is a perspective view of an assembled lure of FIG. 8 in accordance with one embodiment of the invention;

FIG. 10 A-C are different views of a lure card in accordance with one embodiment of the invention;

FIG. 11 A-C are different views of a lure gift card in accordance with one embodiment of the invention;

FIG. 12 A-C are different views of a lure business card in accordance with one embodiment of the invention; and

FIG. 13 A-C are different views of a lure business card in accordance with one embodiment of the invention.

### DETAILED DESCRIPTION OF THE DRAWINGS

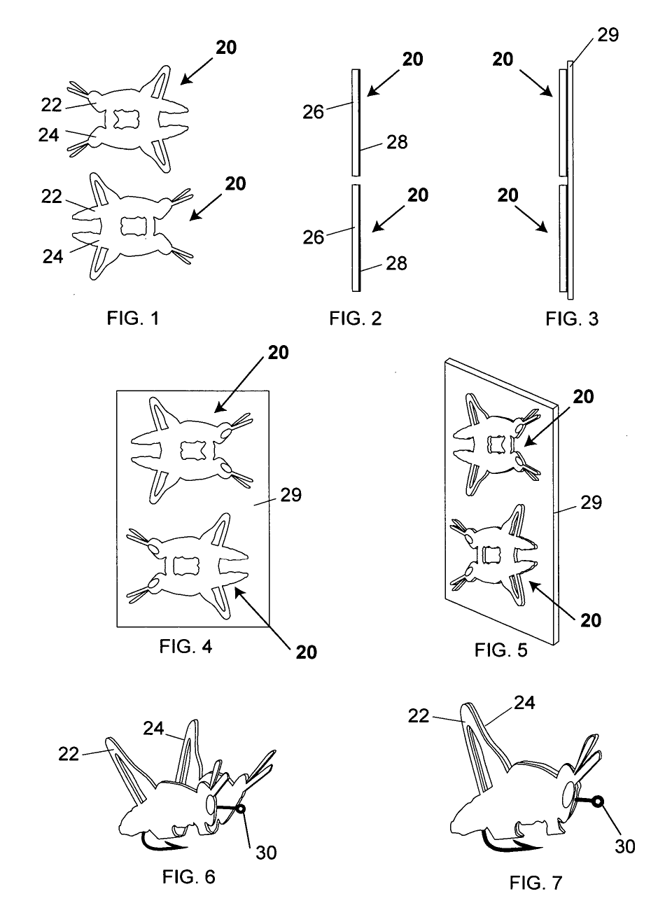

The present invention discusses how to build a two dimensional fishing lure. FIG. 1 is a front view of a two dimensional lure 20 in accordance with one embodiment of the invention. The lure has a pair of images 22, 24 which may be mirror images in one embodiment. The pair of images 22, 24 has an adhesive on the back side so that when the images are folded over they adhere to form the lure. FIG. 2 is a side view of a two dimensional lure 20 in accordance with one embodiment of the invention. Note that the lure 20 has a base material 26 and a backing material 28. An adhesive may be placed on the back side of the base material 26 or between the base material and the low stick back material 28. FIG. 3 is a side view of a two dimensional lure 20 on the base material in accordance with one embodiment of the invention before the lure has been punched out from the background material. FIG. 4 is a front view of a two dimensional lure 20 on the base material 26 in accordance with one embodiment of the invention. The base material 26 may be scored to form the lures 20 so that they may be punch out. FIG. 5 is a perspective view of a two dimensional lure 20 on the base material 26 in accordance with one embodiment of the invention. In one embodiment, the base material is a mylar, plastic or other flexible, water proof material. An artistic design may be placed on the lure 20.

FIG. 6 is a perspective view of a two dimensional lure 20 being folded over a hook 30 in accordance with one embodiment of the invention. When the two images 22, 24 are secured together over the hook 30 the lure is ready for use, as shown in FIG. 7.

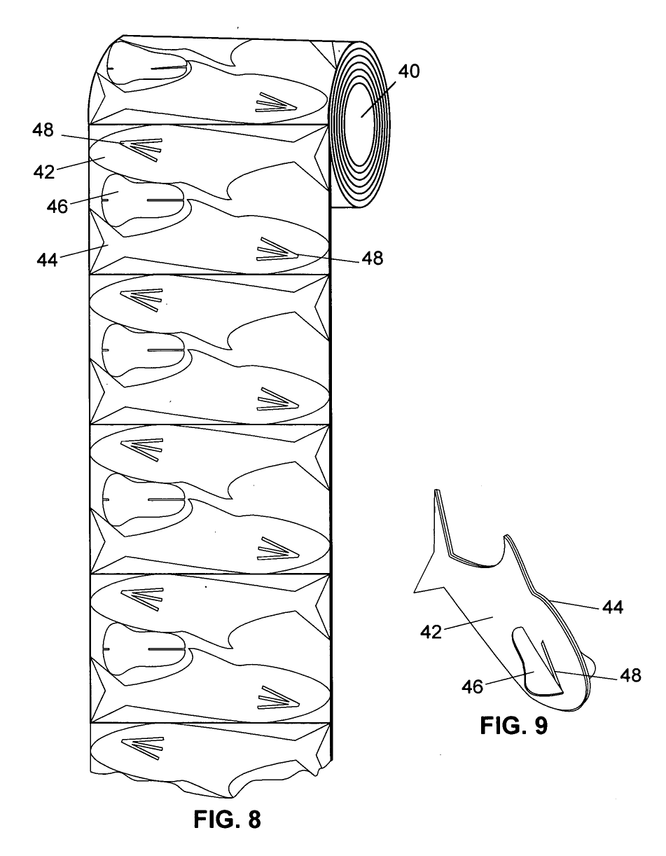

FIG. 8 is a perspective view of a roll 40 of two dimensional lures in accordance with one embodiment of the invention. The lures in this case have two lure bodies 42, 44 and a swim plane 46. The swim plane 46 may be inserted into a slot 48 in the lure bodies 42, 44 as shown in FIG. 9. This provides for more action in the lure as it is pulled through the water.

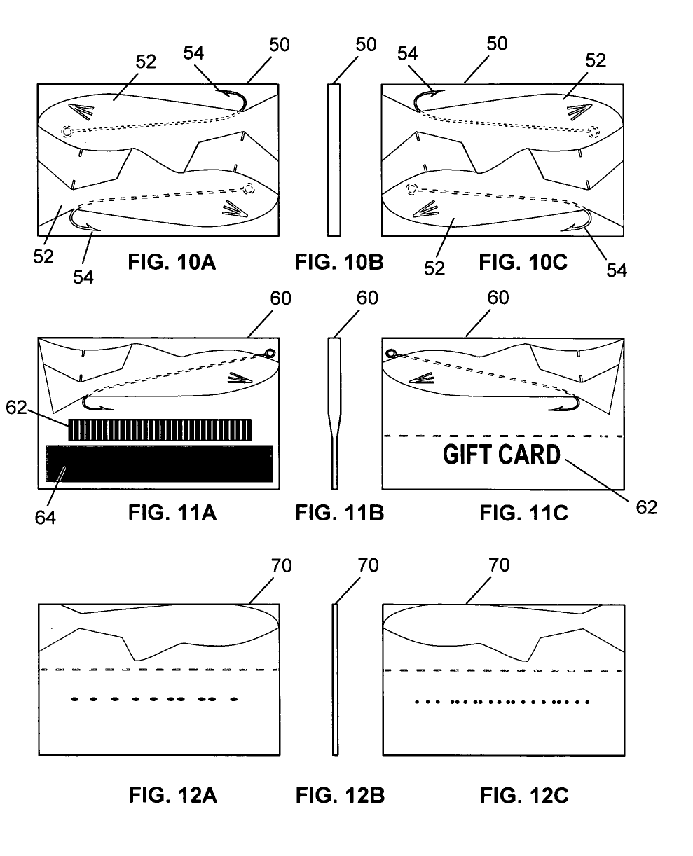

FIG. 10 A-C are different views of a lure card 50 in accordance with one embodiment of the invention. The lure card 50 has two images 52 that may be a complete lure with a hook 54. FIG. 11 A-C are different views of a lure gift card 60 in accordance with one embodiment of the invention. This is similar to the lure card 50 but has printing 62 and may contain a magnetic strip 64. FIG. 12 A-C are different views of a lure business card 70 in accordance with one embodiment of the invention. This is similar to the gift card.

FIG. 13 A-C are different views of a lure business card 80 in accordance with one embodiment of the invention. This lure business card 80 has a lure 82 in an opening 84 in the card. The lure 82 is encased in a clear material 86 which may b plastic.

A two dimensional fishing lure is formed by having a shape of the lure scored in a two dimension surface such as a sheet of paper, plastic, mylar, rubber, etc. Commonly two mirror images of the lure are scored in the sheet of material. The sheet of material contains a front surface that has an artistic design appropriate for that type of fishing lure. The back surface of the material may be partially covered by an adhesive with a low stick peel off paper (material) covering the adhesive. The user punches out the lure from the sheet of material and peels off the low stick backing material. A hook is placed between the two mirror images as they are folded over on each other. Note that some lures may have the mirror images overlap each other exactly to form the lure, while other lures will have the images slightly offset from each other. Other variations on the two dimensional lure include folding surfaces to provide a third dimension to the lure or punch out panels that are used to form planes (fin like surfaces). The planes may be attached to the lure by sliding the plane into a slot of the lure.

The two mirror images may be placed on a card, such as a business card or a gift card. Alternatively the two mirror images may be placed on a role of sheet material. Note that the two mirror images do not have to be perfect mirror images. There may be advantages to having slight differences between the two images. A hook may be attached to one of the surfaces of the material for use with the lure. The hook may be attached with an adhesive and may have a removable cover over the tip of the hook. For instance, a glob of glue may completely cover the hook so that it does not accidentally bard the user. Once the hook is peeled from the surface, the glob of glue can be easily removed from the hook.

The front surface of the lures may be painted or printed on to create a lure that is attractive to fish. In addition, the front surface may have other surfaces laminated to it to form interesting designs.

In one version of the lure, a business card has a void that is enclosed by two clear pieces of plastic or other material. Inside of the two pieces of plastic is enclosed a lure, such as a fly.

Thus there has been described a two dimensional lure that is not as bulky as present fishing lures, may be used as a business card or other cards and is inexpensive.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A two dimensional fishing lure, comprising:
a base material;
a pair of images scored in the base material.

2. The lure of claim 1, wherein the base material has a pair of layers.

3. The lure of claim 2, wherein a first layer of the pair of layers has a front surface that has a design inside the pair of images and has a back surface that contains an adhesive.

4. The lure of claim 3, wherein a second layer of the pair of layers is a low stick peel off material that covers the adhesive.

5. The lure of claim 1, wherein the pair of images are mirror images.

6. The lure of claim 1, further including a punch out section that is separate from the pair of images.

7. The lure of claim 1, wherein the base material contains printing.

8. The lure of claim 7, wherein the pair of images contain transferable ink.

9. A method of making a fishing lure, comprising:
a) forming a pair of two dimensional images; and
b) placing a hook between the pair of two dimensional images to form a sandwich.

10. The method of claim 9, further including the step of:
c) affixing the pair of two dimensional images to each other.

11. The method of claim 9, wherein step (a) further includes the step of:
a1) scoring a backing material to form the pair of two dimensional images.

12. The method of claim 9, wherein step (a) further includes the step of:
a1) creating a design on the pair of two dimensional images.

13. The method of claim 9, wherein step (a) further includes the steps of:
a1) printing on the base material;
a2) cutting the base material into a business card size.

14. A fishing lure card, comprising:
a base material; and
a fishing lure within the base material.

15. The lure of claim 14, wherein the base material has a cutout section and the fishing lure is within the base material.

16. The lure of claim 15, wherein the fishing lure is encased in a clear plastic material.

17. The lure of claim 14, wherein the fishing lure is scored in the base material.
